(19) United States
(12) Patent Application Publication
(10) Pub. No.: US 2026/0370002 A1
(43) Pub. Date: Nov. 19, 2026

(54) METHOD AND SYSTEM FOR CONSTRUCTING RIVER BASIN HYDRO-WIND-SOLAR COMPLEMENTARY OPERATING RULES TO ENHANCE SUPPORT FOR POWER GRID SHORT-TERM FLEXIBILITY

(71) Applicant: DALIAN UNIVERSITY OF TECHNOLOGY, Dalian (CN)

(72) Inventors: Jianjian SHEN, Dalian (CN); Mengke LIN, Dalian (CN); Feng LIU, Dalian (CN); Huazhang SUN, Dalian (CN); Xianren AI, Dalian (CN); Lianjie LI, Dalian (CN); Yuqian WANG, Dalian (CN); Qian LIU, Dalian (CN); Yongzhen WU, Dalian (CN)

(21) Appl. No.: 19/576,447

(22) Filed: Mar. 24, 2026

(30) Foreign Application Priority Data
Dec. 16, 2025 (CN) 202511895619.8

(51) Int. Cl. H02J 3/17; G05B 13/02; H02J 101/22; H02J 101/28; H02J 101/40; H02J 103/35

(52) U.S. Cl. CPC H02J 3/17; G05B 13/027; H02J 2101/22; H02J 2101/28; H02J 2101/40; H02J 2103/35

(57) ABSTRACT

The present invention belongs to the field of power system generation dispatching, and discloses a method and system for constructing river basin hydro-wind-solar complementary operating rules to enhance support for power grid short-term flexibility. Based on the typical intraday two-stage generation profile of hydropower under stand-alone operation, combined with regulation capacity and regulation duration, the short-term flexibility demands of the power grid are quantified. Using the grid demands as constraints, a short-term time-series simulation-optimization model is constructed to generate monthly peak-shaving functions. With monthly hydropower generation boundaries as constraints and using the peak-shaving function as a guiding mechanism, a long-term multi-objective and long time-series optimization model is established and solved. Finally, the optimal long-term operating rules for the hydro-wind-solar complementary system are finally determined by fitting monthly operating functions using a BP neural network and combining them with the optimal cascade energy storage intervals derived from the long-term model results.

### TECHNICAL FIELD

The present invention pertains to the field of power system dispatch and relates to a method and system for constructing river basin hydro-wind-solar complementary operating rules to enhance support for power grid short-term flexibility.

### BACKGROUND TECHNOLOGY

The growing penetration of variable renewable energy sources, such as wind and solar power, has intensified net load fluctuations and placed significant peak regulation pressure on power grids. In response, hydropower, especially in regions with abundant water resources, has become increasingly vital due to its rapid regulation capabilities. In fact, most hydropower facilities now operate in conjunction with wind-solar power, forming integrated hydro-wind-solar complementary systems. These systems leverage the flexible regulation of hydropower to mitigate renewable variability and provide essential peak-shaving support, playing a crucial role in maintaining grid stability. However, the short-term effectiveness of hydropower in this role is highly dependent on sound long-term operation strategies. In particular, the adequacy of the monthly generation schedule directly dictates its peak-shaving performance: an overly ambitious schedule may consume the unit's regulation margin, hindering its ability to respond to peak and off-peak demands, while an overly conservative schedule may weaken its supportive capacity, resulting in insufficient peak-shaving capability.

Currently, long-term operation research on hydro-wind-solar complementary systems mainly focuses on dispatch plan generation or conventional operating rules extraction. In terms of long-term peak-shaving, existing studies often treat it as a optimization objective, failing to fully account for the quantification of daily peak-shaving needs of the power grid within a month. (Jiang J, Ming B, Liu P, et al. Refining long-term operation of large hydro-photovoltaic-wind hybrid systems by nesting response functions[J]. Renewable Energy, 2023, 204: 359-371). This limitation may lead to two types of issues: first, excessive pursuit of peak-shaving goals can sacrifice the system's overall power generation benefits, resulting in suboptimal economic performance (Lin M K, Shen J J, Cheng C T, et al. Long-term multi-objective optimal scheduling for large cascaded hydro-wind-photovoltaic complementary systems considering short-term peak-shaving demands[J]. Energy Conversion and Management, 2024, 301: 118063); second, the actual peak-shaving demands of the grid may remain unmet, causing a mismatch between long-term planning and short-term operation, which not only leads to economic losses but also increases system operational risks (Tan Q, Zhang Z, Wen X, et al. Risk control of hydropower-photovoltaic multi-energy complementary scheduling based on energy storage allocation[J]. Applied Energy, 2024, 358: 122610).

It is also important to note that the grid's peak-shaving demand itself exhibits a dynamic growth trend. With the continued expansion of installed capacity from variable renewable energy sources, the peak-to-valley load difference is expected to widen further. As a result, the grid's requirements for peak-shaving support from hydro-wind-solar complementary systems will become increasingly stringent, thereby exacerbating the aforementioned risks. Consequently, effectively integrating dynamically evolving peak-shaving demands into long-term operating rules has become a critical challenge for enhancing system operational performance.

To address the issues outlined above, the present invention, based on the engineering context of a large-scale hydro-wind-solar complementary system in a typical hydropower base in southwestern China, proposes a method and system for constructing hydropower operating rules of the complementary system that enhance short-term flexibility support for the power grid. This approach combines the quantitative modeling of grid peak-shaving demands, refined short-term operation simulation, and long-term optimal dispatch to reshape the hydropower generation profile on a monthly basis. Based on this, operating rules that balance long-term power generation benefits with short-term flexibility are extracted. Finally, through a practical case study, the effectiveness and superiority of the proposed method are validated from two dimensions: long-term economic benefits and short-term peak-shaving capability.

### INVENTION CONTENT

The present invention aims to provide a method and system for constructing hydropower operating rules for a hydro-wind-solar complementary system, with the objective of enhancing support for power grid short-term flexibility. In response to the growing short-term flexibility requirements of power grids, the invention seeks to fully exploit the flexibility potential of hydro-wind-solar complementary systems. By integrating the short-term power flexibility needs of power grid, the invention establishes a set of hydropower operating rules and an applicable system, thereby improving the ability of the hydro-wind-solar complementary system to support grid flexibility demands.

### Technical Solution of the Present Invention

1. A method for constructing river basin hydro-wind-solar complementary operating rules to enhance support for power grid short-term flexibility, comprising the following steps:
   (1) characterizing power grid short-term flexibility demands;
   for a given month, based on a typical two-stage (peak and valley) intraday generation profile of the hydropower station, considering regulation capacity Pc and regulation duration Pd, the minimum daily peak-shaving electricity demand Pe and the minimum daily electricity demand PBe of the power grid for the month are quantified as follows:

Pc=Nₚ−Nᵥ (1)

Pe=Pc×Pd (2)

PBe=Pe+Nᵥ×Pd (3)
wherein Nₚ and Nᵥ are peak output and valley output of the typical two-stage (peak and valley) intraday generation profile of the hydropower station respectively;
(2) constructing a short-term time-series simulation optimization model to obtain monthly peak-shaving functions and monthly hydropower generation boundaries satisfying the power grid short-term flexibility demands, with the objective function as follows:

$$Max PE = ( {\sum }_{d ∈ D} {\sum }_{s ∈ S} {C}_{s} \times {Pe}_{d , s} ) / card ( D ) \qquad ( 4 )$$

$${Pe}_{d , s} = {\sum }_{i ∈ {I}_{p}} ( {P}_{d , s , i} - {\underline{P}}_{d , s} ) \qquad ( 5 )$$

wherein PE is a peak-shaving electricity target value; D is a set of days for daily wind-solar output for the month over multiple years; S is the number of wind-solar scenarios for a typical intraday wind-solar generation profile; Cₛ is the probability corresponding to the wind-solar scenarios; card(g) is the length of the set of days; Pe_{d,s} is Peak-Shaving Electricity for the d^{th} Day Under the Wind-Solar scenario s; Iₚ is a set of time periods corresponding to the peak output of the typical two-stage (peak and valley) intraday generation profile of the hydropower station for the month; P_{d,s,i} is an output value of a hydro-wind-solar complementary system at intraday time i for the d^{th} day under the wind-solar scenario s; and P_{d,s} is average output of the hydro-wind-solar complementary system in an intraday valley time period for the d^{th} day under the wind-solar scenario s;
the monthly peak-shaving functions and the monthly hydropower generation boundaries satisfying the power grid short-term flexibility demands are simulated twice, and the constraints thereof comprise constraints corresponding to simulation of monthly peak-shaving function relationships and constraints corresponding to simulation of monthly hydropower generation boundaries;
2.1) corresponding to simulation of monthly peak-shaving function relationships;
the output of hydropower and wind-solar power at different time scales needs to satisfy multi-scale power and electricity conservation constraints, and the constraint conditions are as follows:

$${\sum }_{d ∈ {M}_{k}} {\sum }_{i ∈ I} {PH}_{d , s , i} / [ card ( I ) * card ( {M}_{k} ) ] = PH ∀ {M}_{k} ∈ R \qquad ( 6 )$$

$${\sum }_{i ∈ I} {PW}_{d , s , i} / card ( I ) = {PW}_{d} d ∈ D \qquad ( 7 )$$

wherein Mₖ is a set of days for the k^{th} year in the set D of days for daily wind-solar output for the month over multiple years; R is a set of all months, and R={M₁, M₂, . . . , M_{K}}; PH is monthly scale output of a hydropower station; PW_{d} is output of wind-solar power on the d^{th} day; PH_{d,s,i} and PW_{d.s,i} are output of hydropower and wind-solar power at the intraday time i for the d^{th} day under the wind-solar scenario s respectively; and I is a set of time periods of the typical two-stage (peak and valley) intraday generation profile of the hydropower station for the month;
2.2) constraints corresponding to simulation of monthly hydropower generation boundaries;
the daily electricity and the peak-shaving electricity of the hydro-wind-solar complementary system within a month need to satisfy the power grid short-term flexibility demands, the minimum daily peak-shaving electricity demand Pe and the minimum daily electricity demand PBe obtained in step (1) are introduced, and the constraint conditions are as follows:

$${P}_{d , s , i} = {PH}_{d , s , i} + {PW}_{d , s , i} \qquad ( 8 )$$

$${\sum }_{i ∈ I} {P}_{d , s , i} Δ i \geq PBe \qquad ( 9 )$$

$${\sum }_{i ∈ {I}_{p}} ( {P}_{d , s , i} - {\underline{P}}_{d , s} ) Δ i \geq Pe \qquad ( 10 )$$

wherein Δi is duration of a unit time period, in hours;
2.3) during the two simulation processes, the following steps are followed: first, carrying out discretization between the minimum hydropower output 0 and the maximum hydropower output P^{max} to obtain a hydropower output sequence [PH₁, PH₂, . . . , PH_{M}], and successively substituting the monthly scale output PH of a hydropower station in formula (6) with the hydropower output value PHₘ in the hydropower output sequence for repeated optimization calculation;
in the simulation of monthly peak-shaving function relationships: collecting peak-shaving electricity target values [PE₁, PE₂, . . . , PE_{M}] obtained from each optimization of the short time-series simulation optimization model, drawing the peak-shaving curve of each month of the hydro-wind-solar complementary system accordingly based on the hydropower output sequence [PH₁, PH₂, . . . , PH_{M}] and the peak-shaving electricity target values [PE₁, PE₂, . . . , PE_{M}], and fitting the peak-shaving curve of each month into the peak-shaving function of each month; and conducting monthly simulation calculation throughout the year to obtain the monthly peak-shaving function f^{t}(g)t∈T reflecting the annual changes;
in the simulation of monthly hydropower generation boundaries: if a certain hydropower output value PHₘ in the hydropower output sequence has no solution during the optimization process, the hydropower output value PHₘ is considered infeasible; collecting all hydropower output values with solutions to determine feasible hydropower generation boundary intervals for the month; and conducting simulation calculation for each month throughout the year to finally obtain monthly hydropower generation boundary intervals

$$[ {P}_{t}^{min} , {P}_{t}^{max} ] t ∈ T$$

of the year;
(3) constructing a long-term multi-objective and long time-series hydro-wind-solar optimal dispatching model;
3.1) the objective functions are as follows:

$$Max EP = {\sum }_{n ∈ N} {\sum }_{t ∈ T} ( {P}_{n , t} + {P}_{wp , t} ) Δ t \qquad ( 11 )$$

$$Max PR = {\sum }_{t ∈ T} {f}^{t} ( {\sum }_{n ∈ N} {P}_{n , t} ) \qquad ( 12 )$$

wherein EP is power generation of the hydro-wind-solar complementary system in the entire dispatching cycle; N is a set of hydropower stations; T is a set of a long time-series dispatching time periods; P_{n,t} is output of a hydropower station n in the t month; P_{wp,t} is output of wind-solar power in the t month; Δt is monthly duration; PR is peak-shaving electricity of the hydro-wind-solar complementary system in the entire dispatching cycle; and ƒ^{t}(g) is a monthly peak-shaving function of for the t month;
3.2) the constraint condition is as follows:

$${P}_{t}^{min} \leq {\sum }_{n ∈ N} {P}_{n , t} \leq {P}_{t}^{max} \qquad ( 13 )$$

$$wherein {P}_{t}^{min} and {P}_{t}^{max}$$

are a lower boundary and an upper boundary of hydropower output for the t month respectively, both obtained in step (2);
(4) constructing river basin hydro-wind-solar complementary operating rules, comprising monthly operating functions and monthly cascade energy storage regulation intervals;
based on the optimization results of the long-term multi-objective and long time-series hydro-wind-solar optimal dispatching model constructed in step (3), with the initial reservoir capacity, runoff and wind-solar output of the current month as input and with any one variable among the hydropower output, end-of-month reservoir capacity or discharge flow as output, a BP neural network is used for monthly fitting, and the monthly operating functions are determined according to the fitting results; and energy storage calculation is carried out on the lower boundary and the upper boundary of the monthly reservoir capacity process in the optimization results of the long-term multi-objective and long time-series hydro-wind-solar optimal dispatching model in step (3) to obtain monthly cascade energy storage regulation intervals, so as to form energy storage dispatching boundaries; wherein the method for calculating energy storage is as follows:

$${ES}_{n , t} = \frac{{V}_{n , t} + {\sum }_{n ∈ {Ω}_{n}} {V}_{n , t}}{{η}_{n , t}} \qquad ( 14 )$$

$${ES}_{t} = {\sum }_{n ∈ N} {ES}_{n , t} \qquad ( 15 )$$

wherein ES_{n,t} is energy storage of the hydropower station n in the t month; V_{n,t} is reservoir capacity of the hydropower station n in the t month; Ωₙ is a set of hydropower stations n upstream of the hydropower station; η_{n,t} is an average water consumption rate of the hydropower station n in the t month; and ESₜ is total energy storage of cascade hydropower stations in the t month.
2. A system for constructing river basin hydro-wind-solar complementary operating rules to enhance support for power grid short-term flexibility, comprising:
   a power grid short-term flexibility demand module, used for calculating the minimum daily peak-shaving electricity demand and the minimum daily electricity demand of power grids within a month based on the typical two-stage (peak and valley) intraday hydropower generation profile; the power grid short-term flexibility demand module quantifies the requirements of the power grids for regulation capacity and regulation duration of a hydro-wind-solar complementary system by introducing an index set of regulation capacity and regulation duration; and calculates peak-shaving electricity and basic electricity through the regulation capacity and the regulation duration, so as to achieve the quantification of the minimum daily peak-shaving electricity demand and the daily electricity demand of the power grids within a month;
   a short time-series simulation optimization module, used for constructing a short-term time-series simulation optimization model considering typical intraday output scenarios of multiple consecutive days and multiple wind-solar scenarios within a month under the constraints of the power grid short-term flexibility demand module, so as to achieve simulation of monthly peak-shaving function relationships and simulation of monthly hydropower generation boundaries; and used for conducting repeated simulation optimization calculation with discrete elements of hydropower output intervals as input, so as to obtain monthly peak-shaving functions and monthly hydropower generation boundaries satisfying the power grid short-term flexibility demands;
   a long-term multi-objective and long time-series hydro-wind-solar optimal dispatching module, used for integrating the output results of the short-term time-series simulation optimization module and constructing a long-term multi-objective and long time-series hydro-wind-solar optimal dispatching model by introducing two objectives of maximum power generation of the hydro-wind-solar complementary system in the entire dispatching cycle and maximum peak-shaving electricity of the hydro-wind-solar complementary system in the entire dispatching cycle, so as to solve the optimal multi-year monthly dispatching results of the river basin hydro-wind-solar complementary system at a long time-series scale;
   a river basin hydro-wind-solar complementary regulation module, used for utilizing the optimal multi-year monthly dispatching results obtained by the long-term multi-objective and long time-series hydro-wind-solar optimal dispatching module to introduce a BP neural network to fit monthly operating functions of each hydropower station among cascade hydropower stations; and meanwhile, used for calculating monthly cascade energy storage regulation intervals based on the upper and lower boundaries of hydropower output of the optimal monthly reservoir capacity process set obtained by the long-term multi-objective and long time-series hydro-wind-solar optimal dispatching module, so as to achieve long-term optimal dispatching of the river basin hydro-wind-solar complementary system.
3. A computer device, comprising a storage medium, a processor and a computer program stored in the storage medium and capable of running in the processor, wherein the processor, when executing the computer program, implements a system for constructing river basin hydro-wind-solar complementary operating rules to enhance support for power grid short-term flexibility.
4. A storage medium, storing a computer program which, when executed by a processor, implements a system for constructing river basin hydro-wind-solar complementary operating rules to enhance support for power grid short-term flexibility.

The present invention proposes a quantitative method for characterizing grid peak-shaving demands and systematically integrates it into the long-term operating rule construction process for hydro-wind-solar complementary systems. By incorporating the long-term generation boundary constraints derived from short-term time-series model and establishing the peak-shaving function guidance mechanism, the method optimizes the hydropower energy allocation strategy on a monthly scale throughout the year. This approach enhances both the system's ability to satisfy long-term peak-shaving demands and its dynamic adaptability to address short-term flexibility requirements of power grid, while maintaining overall operational efficiency.

### DESCRIPTION OF DRAWINGS

FIG. 1 illustrates the schematic diagram of hydropower typical generation profile;

FIG. 2 illustrates the short-term simulation flowchart for a certain month;

FIG. 3 illustrates the comparison of optimization results with simulation runs of the operating rules. (a) optimization results for conventional model; (b) simulation results of operating rules-1; (c) optimization results for proposed model; and (d) simulation results of operating rules-2;

FIG. 4 illustrates the monthly power distribution obtained with operating rules-2 on the validation dataset;

FIG. 5 illustrates the monthly power distribution obtained with operating rules-1 on the validation dataset;

FIG. 6 illustrates the comparison of monthly output and peak-shaving electricity of different operating rules. (a) monthly generation based on simulation results (b) cumulative peak-shaving electricity and (c) monthly peak-shaving electricity;

FIG. 7 illustrates the monthly power grid demands.

FIG. 8 illustrates the flowchart of the method of the present invention.

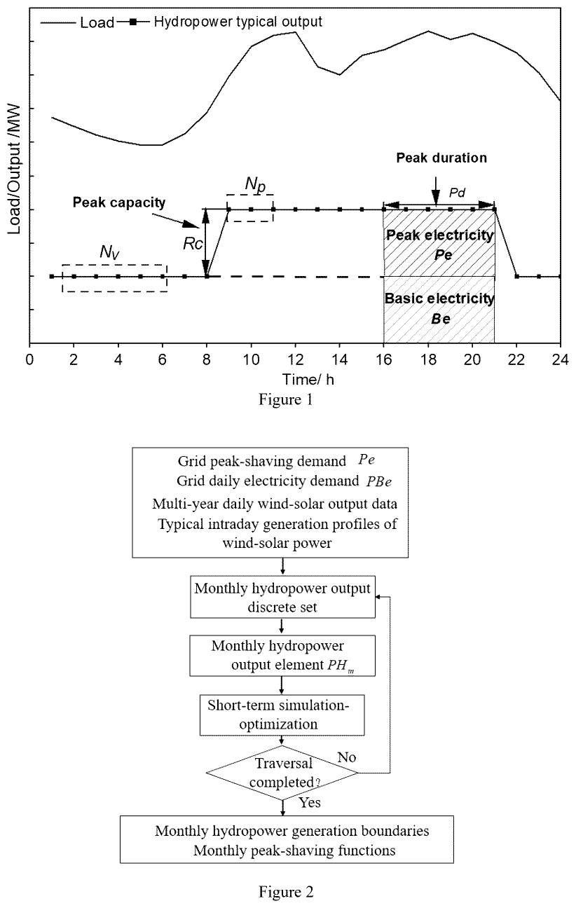

### DETAILED DESCRIPTION

The specific embodiments of the present invention are further described below in conjunction with the accompanying drawings and the technical solution;
(1) characterizing power grid short-term flexibility demands;
for a given month, based on a typical two-stage (peak and valley) intraday generation profile of the hydropower station, considering regulation capacity Pc and regulation duration Pd, the minimum daily peak-shaving electricity demand Pe and the minimum daily electricity demand PBe of the power grid for the month are quantified as follows:

Pc=Nₚ−Nᵥ (16)

Pe=Pc×Pd (17)

PBe=Pe+Nᵥ×Pd (18)
the method is applied across all 12 months of the year to derive the minimum daily peak-shaving electricity demand and the minimum daily electricity demand of the power grid for each individual month;
(2) constructing a short-term time-series simulation optimization model to obtain monthly peak-shaving functions and monthly hydropower generation boundaries satisfying the power grid short-term flexibility demands;
the daily wind-solar power output time-series dataset for the calculation month over the past n years is obtained and denoted as {y₁, y₂, . . . , yₙ}, wherein yⱼ represents the daily wind-solar output data for the j^{th} year;
cluster analysis is performed on the intraday generation profiles of wind-solar power for that month to derive typical intraday generation profiles (number of profiles: S);
for the daily wind-solar output time series of any given year, each typical intraday generation profile is proportionally scaled based on the corresponding daily output value to generate the respective intraday generation profile;
constructing a short-term time-series simulation optimization model with the following objective function:

$$Max PE = ( {\sum }_{d ∈ D} {\sum }_{s ∈ S} {C}_{s} \times {Pe}_{d , s} ) / card ( D ) \qquad ( 19 )$$

$${Pe}_{d , s} = {\sum }_{i ∈ {I}_{p}} ( {P}_{d , s , i} - {\underline{P}}_{d , s} ) \qquad ( 20 )$$

the monthly peak-shaving functions and the monthly hydropower generation boundaries satisfying the power grid short-term flexibility demands are simulated twice, and the constraints thereof comprise constraints corresponding to simulation of monthly peak-shaving function relationships and constraints corresponding to simulation of monthly hydropower generation boundaries;
2.1) corresponding to simulation of monthly peak-shaving function relationships;
the output of hydropower and wind-solar power at different time scales needs to satisfy multi-scale power and electricity conservation constraints, and the constraint conditions are as follows:

$${\sum }_{d ∈ {M}_{k}} {\sum }_{i ∈ I} {PH}_{d , s , i} / [ card ( I ) * card ( {M}_{k} ) ] = PH ∀ {M}_{k} ∈ R \qquad ( 21 )$$

$${\sum }_{i ∈ I} {PW}_{d , s , i} / card ( I ) = {PW}_{d} d ∈ D \qquad ( 22 )$$

2.2) constraints corresponding to simulation of monthly hydropower generation boundaries;
the daily electricity and the peak-shaving electricity of the hydro-wind-solar complementary system within a month need to satisfy the power grid short-term flexibility demands, the minimum daily peak-shaving electricity demand and the minimum daily electricity demand obtained in step (1) are introduced, and the constraint conditions are as follows:

$${P}_{d , s , i} = {PH}_{d , s , i} + {PW}_{d , s , i} \qquad ( 23 )$$

$${\sum }_{i ∈ I} {P}_{d , s , i} Δ i \geq PBe \qquad ( 24 )$$

$${\sum }_{i ∈ {I}_{p}} ( {P}_{d , s , i} - {\underline{P}}_{d , s} ) Δ i \geq Pe \qquad ( 25 )$$

in addition, the constraints for both include variable boundary constraints and coordinated regulation constraints, as specified below:
variable boundary constraints

$${P}_{d , s , i} \leq {Tc}^{max} \qquad ( 26 )$$

$${PH}_{i}^{min} \leq {PH}_{d , s , i} \leq {PH}_{i}^{max} \qquad ( 27 )$$

wherein Tc^{max} is the maximum transmission capacity;

$${PH}_{i}^{min} and {PH}_{i}^{max}$$

are the minimum and maximum values of PH_{d,s,i};
simultaneous regulation constraints

(P_{d,s,i+1}−P_{d,s,i})=λᵢ×(L_{d,s,i+1}−L_{d,s,i}) (28)
wherein L_{d,s,i} is the typical load value at period i of the s^{th} scenario on day d corresponding to the month; λᵢ is an auxiliary variable (λᵢ≤0) that ensures that the power fluctuation process is consistent with the load fluctuation and helps to reduce the fluctuation of the power allocation process;
2.3) during the two simulation processes, the following steps are followed: first, carrying out discretization between the minimum hydropower output 0 and the maximum hydropower output P^{max} to obtain a hydropower output sequence [PH₁, PH₂, . . . , PH_{M}], and successively substituting the monthly scale output PH of a hydropower station in formula (6) with the hydropower output value PHₘ in the hydropower output sequence for repeated optimization calculation;
in the simulation of monthly peak-shaving function relationships: collecting peak-shaving electricity target values [PE₁, PE₂, . . . , PE_{M}] obtained from each optimization of the short time-series simulation optimization model, drawing the peak-shaving curve of each month of the hydro-wind-solar complementary system accordingly based on the hydropower output sequence [PH₁, PH₂, . . . , PH_{M}] and the peak-shaving electricity target values [PE₁, PE₂, . . . , PE_{M}], and fitting the peak-shaving curve of each month into the peak-shaving function of each month; and conducting monthly simulation calculation throughout the year to obtain the monthly peak-shaving function ƒ^{t}(g) t∈T reflecting the annual changes;
in the simulation of monthly hydropower generation boundaries: if a certain hydropower output value PHₘ in the hydropower output sequence has no solution during the optimization process, the hydropower output value PHₘ is considered infeasible; collecting all hydropower output values with solutions to determine feasible hydropower generation boundary intervals for the month; and conducting simulation calculation for each month throughout the year to finally obtain monthly hydropower generation boundary intervals

$$[ {P}_{t}^{min} , {P}_{t}^{max} ] t ∈ T$$

of the year;
(3) constructing a long-term multi-objective and long time-series hydro-wind-solar optimal dispatching model;
3.1) the objective functions are as follows.

$$Max EP = {\sum }_{n ∈ N} {\sum }_{t ∈ T} ( {P}_{n , t} + {P}_{wp , t} ) Δ t \qquad ( 29 )$$

$$Max PR = {\sum }_{t ∈ T} {f}^{t} ( {\sum }_{n ∈ N} {P}_{n , t} ) \qquad ( 30 )$$

wherein EP is power generation of the hydro-wind-solar complementary system in the entire dispatching cycle; N is a set of hydropower stations; T is a set of a long time-series dispatching time periods; P_{n,t} is output of a hydropower station n in the t month; P_{wp,t} is output of wind-solar power in the t month; Δt is monthly duration; PR is peak-shaving electricity of the hydro-wind-solar complementary system in the entire dispatching cycle; and ƒ^{t}(g) is a monthly peak-shaving function of for the t month;
3.2) the constraint condition is as follows:

$${P}_{t}^{min} \leq {\sum }_{n ∈ N} {P}_{n , t} \leq {P}_{t}^{max} \qquad ( 31 )$$

(4) constructing river basin hydro-wind-solar complementary operating rules, comprising monthly operating functions and monthly cascade energy storage regulation intervals;
based on the optimization results of the long-term multi-objective and long time-series hydro-wind-solar optimal dispatching model constructed in step (3), with the initial reservoir capacity, runoff and wind-solar output of the current month as input and with any one variable among the hydropower output, end-of-month reservoir capacity or discharge flow as output, a BP neural network is used for monthly fitting, and the monthly operating functions are determined according to the fitting results; and energy storage calculation is carried out on the lower boundary and the upper boundary of the monthly reservoir capacity process in the optimization results of the long-term multi-objective and long time-series hydro-wind-solar optimal dispatching model in step (3) to obtain monthly cascade energy storage regulation intervals, so as to form energy storage dispatching boundaries; wherein the method for calculating energy storage is as follows:

$${ES}_{n , t} = \frac{{V}_{n , t} + {\sum }_{n ∈ {Ω}_{n}} {V}_{n , t}}{{η}_{n , t}} \qquad ( 32 )$$

$${ES}_{t} = {\sum }_{n ∈ N} {ES}_{n , t} \qquad ( 33 )$$

The proposed method is validated using a hydro-wind-solar complementary system located in southwestern China, which comprises two large reservoirs and surrounding wind-solar power stations. The specific configuration is as follows: the total installed capacity of hydropower is 10,050 MW, and the corresponding installed capacity of wind-solar power is 6,500 MW. Based on statistical analysis of actual output data, the initial parameter is set to 10 hours.

Two sets of operating rules are simulated using validation data from 2011 to 2020 to verify and evaluate the superiority of the proposed rules. The operating rules proposed in this invention are denoted as operating rules-1, while the comparative rules are denoted as operating rules-2. The comparative analysis primarily focuses on the performance of these rules, emphasizing their long-term power generation capability and their ability to meet the power grid short-term flexibility demands.

### Evaluation of Long-Term Energy Production

In terms of long-term power generation performance, operating rules-1 proposed in this invention introduces an energy storage control interval to bidirectionally adjust decisions based on the monthly operating function. The specific adjustment logic is as follows: when the calculated energy storage exceeds the upper limit of the interval, the upper limit is used as the constraint target; when it falls below the lower limit, the lower limit is applied. To achieve the energy storage control objective, the system adjusts the discharge flow of the cascade reservoirs proportionally to increase or decrease the stored energy.

Table 1 compares the long-term simulation results under different operating rules. Although operating rules-1 embeds short-term peak-shaving constraints within its short-term simulation-optimization model, its total long-term generation still reaches 52.77 billion kWh. Compared to operating rules-2, which does not incorporate such constraints, the reduction is only 225 million kWh. This marginal difference indicates that rules-1 can effectively safeguard the system's long-term generation benefits while introducing short-term flexibility.

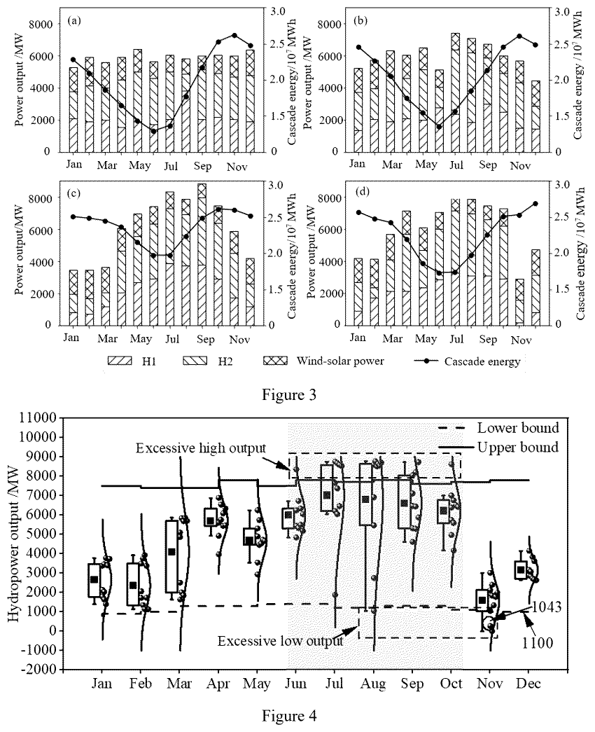

A further comparison between the two operating rules reveals that operating rules-2 prioritizes maximizing power generation during the flood season, but results in a relatively high energy curtailment of 207 million kWh. In contrast, operating rules-1, through balanced optimization, exhibits only 39 million kWh of curtailed energy, demonstrating superior resource utilization efficiency. Simulation results based on long-term hydrological data from 1954 to 2010 (see FIG. 3) show that the multi-year average monthly reservoir storage and generation profiles under both operating rules are in high agreement with the deterministic optimization outcomes, verifying the strong capability of the proposed rules to execute the intent of global optimization.

Furthermore, as shown in FIG. 3, the simulation results under rules-1 exhibit a more strategic energy storage drawdown process. Particularly during the dry season from November to June of the following year, it significantly increases power generation in this period by releasing more stored energy. This “increase in dry season, decrease in flood season” energy redistribution pattern results in a smoother annual generation profile under the guidance of rules-1, demonstrating its effectiveness in coordinating long-term generation benefits with short-term regulation demands.

TABLE 1
Power generation and energy curtailment of
the system under different operating rules.

| | Power generation (10⁸ | Curtailment (10⁸ |
|---|---|---|
| Rule | kWh) | kWh) |
| Operating rules-1 | 527.7 | 0.39 |
| Operating rules-2 | 529.9 | 2.07 |

### Effectiveness in Meeting Short-Term Grid Demands

To evaluate the responsiveness of operating rules to the dynamic demands of the power grid, FIGS. 4 and 5 compare the monthly output distributions of the two rules over a ten-year validation period. The results reveal that operating rules-2 frequently violated the upper output boundary from June to November, with monthly violation probabilities of 10%, 40%, 70%, 30%, 10%, and 30%, respectively. The annual overall violation rate reached 15%, indicating a severe mismatch between its monthly operational decisions and the grid's short-term peak-shaving requirements.

In contrast, operating rules-1 (FIG. 5) demonstrates a significantly improved output distribution. While minor upper-bound violations persist in August (10%) and September (30%), occurrences of output falling below the lower limit are entirely eliminated. Furthermore, the annual overall violation rate is markedly reduced to 3%. This comparison conclusively proves that operating rules-1 can more reliably satisfy the grid's short-term requirements for minimum daily power supply and essential peak-shaving capacity.

### Improvements in Short-Term Regulation Capability

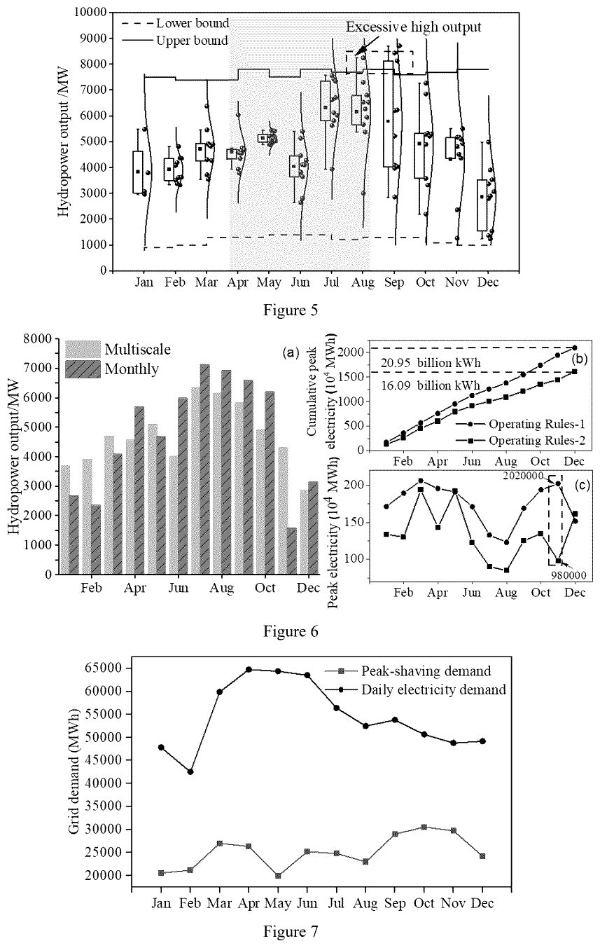

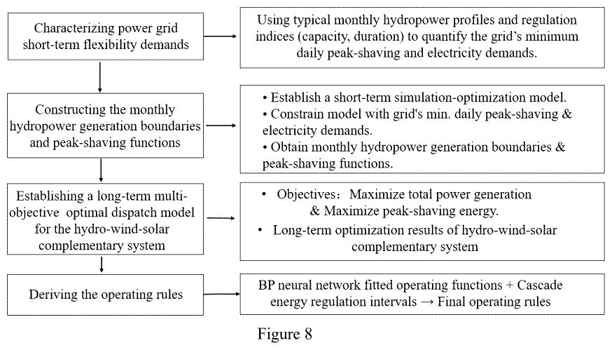

FIG. 6 further quantifies the performance difference between the two rules from the perspective of peak-shaving electricity. Except for slightly lower values in May and December compared to rules-2, the peak-shaving electricity contribution of rules-1 significantly leads in all other months (FIG. 6 (b)), with the most prominent advantage observed in November, exceeding rules-2 by 1.04 billion kWh. In terms of annual totals, the cumulative peak-shaving electricity for rules-1 and rules-2 are 20.95 billion kWh and 16.09 billion kWh, respectively, representing a 30.2% improvement for rules-1 over rules-2 (FIG. 6 (c)).

This significant enhancement stems from rules-1's optimized strategy for annual power allocation: by increasing generation during the dry season (when grid peak-shaving demand is typically higher) and appropriately curtailing it during the flood season, the system's generation profile better aligns with the grid's intraday regulation needs. As shown in FIG. 7, the grid faces higher peak-shaving pressure from March to June. Since rules-1 inherently incorporates dynamic peak-shaving requirements during its modeling phase, it demonstrates superior short-term regulation performance both during this critical period and throughout the entire year.

An embodiment of the present application further provides a computer device, which may specifically be a computer, server, network device, etc. The computer device includes a bus, a processor, a memory, and a communication interface, and may also include an input/output interface and a display device. The processor of the computer device is configured to provide computing and control capabilities. The memory of the computer device includes a non-volatile storage medium and an internal memory. The non-volatile storage medium stores an operating system, computer programs, and a database. The internal memory provides an environment for the operation of the operating system and computer programs in the non-volatile storage medium. The database of the computer device is configured to store location information. The network interface of the computer device is configured to communicate with external terminals via a network connection. When the computer programs are executed by the processor, the steps in the method embodiments are implemented.

Those skilled in the art may understand that the structure of the computer device described above constitutes only a part of the computer device to which the solution of the present application is applied, and does not limit the computer device. A specific computer device may include more or fewer components, combine certain components, or have a different arrangement of components.

In one embodiment, a computer-readable storage medium is also provided. The computer-readable storage medium may be non-volatile or volatile, and has computer programs stored thereon. When the computer programs are executed by a processor, the steps in the aforementioned method embodiments are implemented.

In one embodiment, a computer program product is also provided, including computer programs. When the computer programs are executed by a processor, the steps in the aforementioned method embodiments are implemented.

It should be noted that the user information (including but not limited to user device information, user personal information, etc.) and data (including but not limited to data used for analysis, stored data, displayed data, etc.) involved in the present application are all authorized by users or fully authorized by relevant parties.

Those of ordinary skill in the art may understand that all or part of the processes in the aforementioned method embodiments can be implemented by instructing relevant hardware through computer programs. The computer programs may be stored in a non-volatile computer-readable storage medium. When the computer programs are executed, the processes of the aforementioned method embodiments may be included.

Herein, any reference to a memory, database, or other medium in the embodiments provided in the present application may include at least one of non-volatile memory and volatile memory. Non-volatile memory may include read-only memory (ROM), magnetic tape, floppy disks, flash memory, optical memory, high-density embedded non-volatile memory, resistive random-access memory (ReRAM), magneto resistive random-access memory (MRAM), ferroelectric random-access memory (FRAM), phase-change memory (PCM), graphene memory, etc.

Volatile memory may include random-access memory (RAM) or external cache memory, among others. By way of illustration and not limitation, RAM may take various forms, such as static random-access memory (SRAM) or dynamic random-access memory (DRAM), etc.

The databases involved in the embodiments provided in the present application may include at least one of relational databases and non-relational databases. Non-relational databases may include blockchain-based distributed databases, among others, without limitation. The processors involved in the embodiments provided in the present application may be general-purpose processors, graphics processing units, digital signal processors, programmable logic devices, quantum computing-based data processing logic devices, etc., without limitation.

1. A method for constructing river basin hydro-wind-solar complementary operating rules to enhance support for power grid short-term flexibility, comprising the following steps:
(1) characterizing power grid short-term flexibility demands;
for a given month, based on a typical two-stage (peak and valley) intraday generation profile of the hydropower station, considering regulation capacity PC and regulation duration Pd, the minimum daily peak-shaving electricity demand Pe and the minimum daily electricity demand PBe of the power grid for the month are quantified as follows:
Pc=Nₚ−Nᵥ (1)
Pe=Pc×Pd (2)
PBe=Pe+Nᵥ×Pd (3)
wherein Nₚ and Nᵥ are peak output and valley output of the typical two-stage (peak and valley) intraday generation profile of the hydropower station respectively;
(2) constructing a short-term time-series simulation optimization model to obtain monthly peak-shaving functions and monthly hydropower generation boundaries satisfying the power grid short-term flexibility demands;
(3) constructing a long-term multi-objective and long time-series hydro-wind-solar optimal dispatching model;
(4) constructing river basin hydro-wind-solar complementary operating rules, comprising monthly operating functions and monthly cascade energy storage regulation intervals;
in step (2), the objective functions for constructing a short-term time-series simulation optimization model are as follows:
(4)
(5)
wherein is a peak-shaving electricity target value; is a set of days for daily wind-solar output for the month over multiple years; is the number of wind-solar scenarios for a typical intraday wind-solar generation profile: is the probability corresponding to the wind-solar scenarios; is the length of the set of days; is peak shaving electricity for the th day under the wind-solar scenario; is a set of time periods corresponding to the peak output of the typical two-stage (peak and valley intraday generation profile of the hydropower station for the month: is an output value of a hydro-wind-solar complementary system at intraday time for the th day under the wind-solar scenario; and is average output of the hydro-wind-solar complementary system in an intraday valley time period for the th day under the wind-solar scenario.

2. (canceled)

3. The method for constructing river basin hydro-wind-solar complementary operating rules to enhance support for power grid short-term flexibility according to claim 1, wherein
in step (2), the monthly peak-shaving functions and the monthly hydropower generation boundaries satisfying the power grid short-term flexibility demands are simulated twice, and the constraints thereof comprise constraints corresponding to simulation of monthly peak-shaving function relationships and constraints corresponding to simulation of monthly hydropower generation boundaries;
2.1) corresponding to simulation of monthly peak-shaving function relationships;
the output of hydropower and wind-solar power at different time scales needs to satisfy multi-scale power and electricity conservation constraints, and the constraint conditions are as follows:
$${\sum }_{d ∈ {M}_{k}} {\sum }_{i ∈ I} {PH}_{d , s , i} / [ card ( I ) * card ( {M}_{k} ) ] = PH ∀ {M}_{k} ∈ R \qquad ( 6 )$$
$${\sum }_{i ∈ I} {PW}_{d , s , i} / card ( I ) = {PW}_{d} d ∈ D \qquad ( 7 )$$
wherein Mₖ is a set of days for the k^{th} year in the set D of days for daily wind-solar output for the month over multiple years; R is a set of all months, and R {M₁, M₂, . . . , M_{K}}; PH is monthly scale output of a hydropower station; PW_{d} is output of wind-solar power on the d^{th} day; PH_{d,s,i} and PW_{d,s,i} are output of hydropower and wind-solar power at the intraday time i for the d^{th} day under the wind-solar scenario s respectively; and I is a set of time periods of the typical two-stage (peak and valley) intraday generation profile of the hydropower station for the month;
2.2) constraints corresponding to simulation of monthly hydropower generation boundaries;
the daily electricity and the peak-shaving electricity of the hydro-wind-solar complementary system within a month need to satisfy the power grid short-term flexibility demands, the minimum daily peak shaving electricity demand Pe and the minimum daily electricity demand PBe obtained in step (1) are introduced, and the constraint conditions are as follows:
$${P}_{d , s , i} = {PH}_{d , s , i} + {PW}_{d , s , i} \qquad ( 8 )$$
$${\sum }_{i ∈ I} {P}_{d , s , i} Δ i \geq PBe \qquad ( 9 )$$
$${\sum }_{i ∈ {I}_{p}} ( {P}_{d , s , i} - {\underline{P}}_{d , s} ) Δ i \geq Pe \qquad ( 10 )$$
wherein Δi is duration of a unit time period, in hours;
2.3) during the two simulation processes, the following steps are followed: first, carrying out discretization between the minimum hydropower output 0 and the maximum hydropower output P^{max} to obtain a hydropower output sequence [PH₁, PH₂, . . . , PH_{M}], and successively substituting the monthly scale output PH of a hydropower station in formula (6) with the hydropower output value PH, in the hydropower output sequence for repeated optimization calculation;
in the simulation of monthly peak-shaving function relationships: collecting peak shaving electricity target values [PE₁, PE₂, . . . , PE_{M}] obtained from each optimization of the short time-series simulation optimization model, drawing the peak shaving curve of each month of the hydro-wind-solar complementary system accordingly based on the hydropower output sequence [PH₁, PH₂, . . . , PH_{M}] and the peak shaving electricity target values [PE₁, PE₂, . . . , PE_{M}], and fitting the peak shaving curve of each month into the peak shaving function of each month; and conducting monthly simulation calculation throughout the year to obtain the monthly peak shaving function ƒ^{t}(g) t∈T reflecting the annual changes;
in the simulation of monthly hydropower generation boundaries: if a certain hydropower output value PHₘ in the hydropower output sequence has no solution during the optimization process, the hydropower output value PH is considered infeasible; collecting all hydropower output values with solutions to determine feasible hydropower generation boundary intervals for the month; and conducting simulation calculation for each month throughout the year to finally obtain monthly hydropower generation boundary intervals
$$[ {P}_{t}^{min} , {P}_{t}^{max} ] t ∈ T$$
of the year.

4. The method for constructing river basin hydro-wind-solar complementary operating rules to enhance support for power grid short-term flexibility according to claim 3, wherein
step (3) is specifically as follows:
3.1) the objective functions are as follows:
$$Max EP = {\sum }_{n ∈ N} {\sum }_{t ∈ T} ( {P}_{n , t} + {P}_{wp , t} ) Δ t \qquad ( 11 )$$
$$Max PR = {\sum }_{t ∈ T} {f}^{t} ( {\sum }_{n ∈ N} {P}_{n , t} ) \qquad ( 12 )$$
wherein EP is power generation of the hydro-wind-solar complementary system in the entire dispatching cycle; N is a set of hydropower stations; T is a set of a long time-series dispatching time periods; P_{n,t} is output of a hydropower station n in the t month; P_{wp,t} is output of wind-solar power in the t month; Δt is monthly duration; PR is peak shaving electricity of the hydro-wind-solar complementary system in the entire dispatching cycle; and ƒ^{t}(g) is a monthly peak shaving function of for the t month;
3.2) the constraint condition is as follows:
$${P}_{t}^{min} \leq {\sum }_{n ∈ N} {P}_{n , t} \leq {P}_{t}^{max} \qquad ( 13 )$$
$$wherein {P}_{t}^{min} and {P}_{t}^{max}$$
are a lower boundary and an upper boundary of hydropower output for the t month respectively, both obtained in step (2).

5. The method for constructing river basin hydro-wind-solar complementary operating rules to enhance support for power grid short-term flexibility according to claim 4, wherein
step (4) is specifically as follows:
based on the optimization results of the long-term multi-objective and long time-series hydro-wind-solar optimal dispatching model constructed in step (3), with the initial reservoir capacity, runoff and wind-solar output of the current month as input and with any one variable among the hydropower output, end-of-month reservoir capacity or discharge flow as output, a BP neural network is used for monthly fitting, and the monthly operating functions are determined according to the fitting results; and energy storage calculation is carried out on the lower boundary and the upper boundary of the monthly reservoir capacity process in the optimization results of the long-term multi-objective and long time-series hydro-wind-solar optimal dispatching model in step (3) to obtain monthly cascade energy storage regulation intervals, so as to form energy storage dispatching boundaries; wherein the method for calculating energy storage is as follows:
$${ES}_{n , t} = \frac{{V}_{n , t} + {\sum }_{n ∈ {Ω}_{n}} {V}_{n , t}}{{η}_{n , t}} \qquad ( 14 )$$
$${ES}_{t} = {\sum }_{n ∈ N} {ES}_{n , t} \qquad ( 15 )$$
wherein ES_{n,t} is energy storage of the hydropower station n in the t month; V_{n,t} is reservoir capacity of the hydropower station n in the t month; Ωₙ is a set of hydropower stations n upstream of the hydropower station; η_{n,t} is an average water consumption rate of the hydropower station n in the t month; and ESₜ is total energy storage of cascade hydropower stations in the t month.

6. A system for constructing river basin hydro-wind-solar complementary operating rules to enhance support for power grid short-term flexibility, wherein, which the system is constructed by adopting method for constructing river basin hydro-wind-solar complementary operating rules to enhance support for power grid short-term flexibility according to claim 1, comprising:
a power grid short-term flexibility demand module, used for calculating the minimum daily peak shaving electricity demand and the minimum daily electricity demand of power grids within a month based on the typical two-stage (peak and valley) intraday hydropower generation profile; the power grid short-term flexibility demand module quantifies the requirements of the power grids for regulation capacity and regulation duration of a hydro-wind-solar complementary system by introducing an index set of regulation capacity and regulation duration; and calculates peak-shaving electricity and basic electricity through the regulation capacity and the regulation duration, so as to achieve the quantification of the minimum daily peak-shaving electricity demand and the daily electricity demand of the power grids within a month;
a short time-series simulation optimization module, used for constructing a short-term time-series simulation optimization model considering typical intraday output scenarios of multiple consecutive days and multiple wind-solar scenarios within a month under the constraints of the power grid short-term flexibility demand module, so as to achieve simulation of monthly peak-shaving function relationships and simulation of monthly hydropower generation boundaries; and used for conducting repeated simulation optimization calculation with discrete elements of hydropower output intervals as input, so as to obtain monthly peak-shaving functions and monthly hydropower generation boundaries satisfying the power grid short-term flexibility demands;
a long-term multi-objective and long time-series hydro-wind-solar optimal dispatching module, used for integrating the output results of the short-term time-series simulation optimization module and constructing a long-term multi-objective and long time-series hydro-wind-solar optimal dispatching model by introducing two objectives of maximum power generation of the hydro-wind-solar complementary system in the entire dispatching cycle and maximum peak shaving electricity of the hydro-wind-solar complementary system in the entire dispatching cycle, so as to solve the optimal multi-year monthly dispatching results of the river basin hydro-wind-solar complementary system at a long time-series scale;
a river basin hydro-wind-solar complementary regulation module, used for utilizing the optimal multi-year monthly dispatching results obtained by the long-term multi-objective and long time-series hydro-wind-solar optimal dispatching module to introduce a BP neural network to fit monthly operating functions of each hydropower station among cascade hydropower stations; and meanwhile, used for calculating monthly cascade energy storage regulation intervals based on the upper and lower boundaries of hydropower output of the optimal monthly reservoir capacity process set obtained by the long-term multi-objective and long time-series hydro-wind-solar optimal dispatching module, so as to achieve long-term optimal dispatching of the river basin hydro-wind-solar complementary system.

7. A computer device, comprising a storage medium, a processor and a computer program stored in the storage medium and capable of running in the processor, wherein the processor, when executing the computer program, implements a system for constructing river basin hydro-wind-solar complementary operating rules to enhance support for power grid short-term flexibility.

8. A storage medium, storing a computer program which, when executed by a processor, implements a system for constructing river basin hydro-wind-solar complementary operating rules to enhance support for power grid short-term flexibility.
